(19) United States
(12) Patent Application Publication
(10) Pub. No.: US 2025/0384656 A1
(43) Pub. Date: Dec. 18, 2025

(54) REAL-TIME VESSEL IDENTITY AND IMAGE MATCHING SYSTEM AND OPERATING METHOD THEREOF

(71) Applicant: SHIP AND OCEAN INDUSTRIES R&D CENTER, New Taipei City (TW)

(72) Inventors: YU-TING PENG, Kaohsiung City (TW); YAN-SHENG SONG, Kaohsiung City (TW); CHIEN-HUNG LIU, Kaohsiung City (TW)

(21) Appl. No.: 19/230,078

(22) Filed: Jun. 5, 2025

(30) Foreign Application Priority Data
Jun. 12, 2024 (TW) 113121692

(51) Int. Cl. G06V 10/75; B63B 49/00; G06V 10/764; G06V 20/54; G06V 20/70; G08G 3/00

(52) U.S. Cl. CPC G06V 10/751; B63B 49/00; G06V 10/764; G06V 20/54; G06V 20/70; G08G 3/00; B63B 2203/00; B63B 2213/02; G06V 2201/08

(57) ABSTRACT

The present invention discloses a real-time vessel identity and image matching system and operating method thereof. Specifically, the real-time vessel identity and image matching system comprises a processing module, a storage module, at least one camera and a water surface object information receiving module. The processing module may match the camera location information, image recognition information which are provided by the camera with the water surface information which is provided by the water surface object information receiving module, generating a water surface object information tag. Therefore, the processing module is able to label the water surface object information tag beside the water surface object which is displayed.

### TECHNICAL FIELD

The present invention relates to real-time vessel identity and image matching system and operating method, especially integrating a real-time vessel identity and image matching system and operating method which may instantly label and update the integrated water surface object information and water surface object image information in real-time.

### BACKGROUND OF RELATED ARTS

Generally speaking, a large number of water surface objects such as the frequent shuttling ships and water surface vehicles often appear within the visual range of the port and the sealine. Therefore, in order to effectively control the activities of ships and other water surface objects, most of the ships and other water surface objects will be identified through the signals of the Automatic Identification System (AIS).

However, currently, only the water surface object with a displacement tonnage of twenty tons or more will be required to install with the Automatic Identification System (AIS). Therefore, the water surface object without the installation of the Automatic Identification System (AIS) will present a disadvantage that the identity recognition per se is difficult.

Therefore, despite that the water surface objects have been installed with the Automatic Identification System (AIS), when there are multiple water surface objects in the port, it still depends on time consuming and imprecise manual search and identification of the category of ships.

### SUMMARY

To solve the problems of prior arts, the purpose of the present invention is to provide a real-time vessel identity and image matching system and operating method. Specifically, the real-time vessel identity and image matching system of the present invention includes a processing module, a storage module, at least one camera and a water surface object information receiving module.

The storage module connects to the processing module and the storage module includes at least one water surface object data set. The at least one camera connects to the processing module and the at least one camera includes at least one camera positioning information.

Further, the at least one camera captures at least one monitoring image, and the processing module performs object detection for at least one water surface object of the at least one monitoring image, and the processing module uses the at least one water surface object data set to identify at least one image category of the at least one water surface object via object recognition.

The water surface object information receiving module connects to the processing module. The water surface object information receiving module receives a plurality of water surface object information in an interval time, and the water surface object information receiving module sends the plurality of water surface object information to the processing module.

The processing module matches the at least one camera positioning information, the at least one image category and the plurality of water surface object information, and the processing module generates at least one water surface object information tag. The processing module labels the at least one water surface object information tag on the at least one water surface object in the at least one monitoring image.

Further, an operating method of the real-time vessel identity and image matching system of the present invention includes the following steps. First, the step (A) is providing the real-time vessel identity and image matching system. The step (B) is the water surface object information receiving module receiving plurality of water surface object information in an interval time and the water surface object information receiving module sending the plurality water surface object information to the processing module.

The step of (C) is the process module selecting the at least one camera having a visual field containing the at least one water surface via the plurality of the water surface object information, and capturing the at least one monitoring image. Further, the step of (D) is the processing module performing object detection for the at least one water surface object in the at least one monitoring image, and processing module using the at least one water surface object data set to identify the at least one image category of the at least one water surface object via the object recognition. The processing module recognizes the at least one water surface object which is less than the threshold pixel or is blocked by the obstruction via the at least one monitoring image captured by the at least one camera, and the processing module uses magnificent method to magnify the at least one water surface object to perform the object recognition.

Finally, the step of (E) is the processing module matching the at least one camera positioning information, the at least one image category and the plurality water surface object information to generate the at least one water surface object information tag, and the processing module labeling the at least one water surface object information tag on the at least one water surface object in the at least one monitoring image.

Embodiments of the invention are illustrated by way of example, and not by way of limitation, in the figures of the accompanying drawings in which like reference numerals refer to similar elements.

### BRIEF DESCRIPTION OF THE DRAWINGS

FIG. 1 shows a framework diagram of the real-time vessel identity and image matching system of the embodiment of the present invention.

FIG. 2 illustrates a flow chart of the operating method of the real-time vessel identity and image matching system of the embodiment of the present invention.

### DETAILED DESCRIPTION OF THE INVENTION

In order to understand the technical features and practical efficacy of the present invention and to implement the technical features and practical efficacy in accordance with the contents of the specification, hereinafter, preferred embodiments of the present invention will be described in detail with reference to the accompanying drawings.

The “connection” mentioned in this embodiment does not actually have absolute limitation in space and location. Specifically, the term “connection” should reasonably be understood as any physical connection that can realize the function. The physical connection includes mechanical connection, electrical connection, wired connection or wireless connection, and the invention is not limited to these.

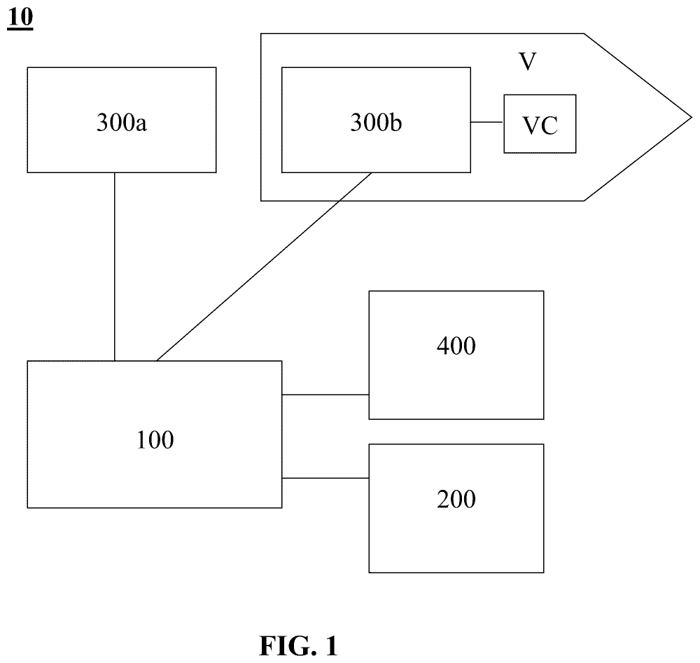

First, please refer to FIG. 1. FIG. 1 is a framework diagram of the real-time vessel identity and image matching system of the embodiment of the present invention. As shown as FIG. 1, the real-time vessel identity and image matching system of the present embodiment includes the processing module 100, the storage module 200, the at least one camera (300a, 300b) and the water surface object information receiving module 400. First of all, in the present embodiment, the processing module 100 connects to the camera 300a and the camera 300b with two different configuring modes.

Specifically, the camera 300a and the camera 300b of the present embodiment receives visible light. In the necessary situation, both the camera 300a and the camera 300b can use invisible light sensing technology, such as thermal image. For instance, once the situation is insufficient of visible light such as at night or on rainy day, the invisible light sensing technology can assist in identification.

Under the condition of sufficient visible light, a plurality of cameras 300a and a plurality of cameras 300b may be configured according to the geographical locations of different ports in the present embodiment, and the present invention is not limited thereto. Specifically, in the present embodiment, the difference between the camera 300a and the camera 300b is their configuring location. The camera 300a is generally configured on the shore, and the camera 300b is configured on a water surface vehicle V. Therefore, the water surface vehicle V carries the camera 300b in the present embodiment. The connection between the camera 300b and the processing module 100 may actually be achieved by wireless communication.

The positions of the camera 300a and the camera 300b affect visual field of the camera 300a and the camera 300b. Therefore, each of the camera 300a or each of the camera 300b includes camera positioning information. The camera 300a or the camera 300b is bullet camera, dome camera or speed dome camera. Taking the camera 300a as an example, actual position and rotatable visual field of the camera 300a which is configured on the shore are fixed. Therefore, the camera positioning information of the camera 300a do not need to be calibrated. The Global Positioning System (GPS) coordinate of the camera 300a is fixed, and the position of the camera 300a is confirmed by the rotated angle of visual field.

In contrast, the camera 300b is carried by water surface vehicle V, thus the camera positioning information of the camera 300b needs to be further calibrated via the nautical instrument VC of the water surface vehicle V. Specifically, the nautical instrument VC can provide information such as the Global Positioning System (GPS) coordinate, heading direction and the other information of the water surface vehicle V as camera navigation correction signal and combine with the known rotation angle of the current visual field of the camera 300b. The camera positioning information of the camera 300b may be calibrated via the camera navigation correction signal and then the camera positioning information of the camera 300b is sent back to the processing module 100.

If the camera 300b has built-in Global Positioning System (GPS), Inertial Measurement Unit (IMU) and the combination components with related functions thereof, the camera 300b can calibrate the camera positioning information by itself without using the nautical instrument VC. In this embodiment, the camera 300b may alternatively compare the camera positioning information with the positioning information of the nautical instrument VC, etc., which is more accurate to calibrate the camera positioning information of the camera 300b.

Therefore, the camera 300a and the camera 300b of the present embodiment have at least three-dimensional camera movement capability. The at least three-dimensional camera movement capability may be three-dimensional image control capability of left and right (Pan), up and down (Tile) and Zoom. Furthermore, in view of the rotation requirement for the abovementioned camera movement, the best rotation angle of the camera 300a and the camera 300b are 120 degrees per second in the present embodiment. In some embodiments, the camera 300a and the camera 300b may have built-in invisible light sensing function such as thermal image, and the present invention is not limited thereto.

Accordingly, the processing module 100 of the present embodiment may clearly know the most likely Global Positioning System (GPS) coordinate of each of water surface object within the visual field which captures by the camera 300a or the camera 300b through camera positioning information from the camera 300a or the camera 300b.

In addition, the monitoring image captured by the camera 300a and the camera 300b of the present embodiment may be output and displayed by connecting to a terminal device with a screen or a display, and the present invention is not limited thereto. Therefore, the processing module 100 of the present embodiment may perform object detection based on the water surface object which appears (entering the visual field of the camera 300a and the camera 300b) in the monitoring image of the camera 300a and the camera 300b. In the present embodiment, the water surface object may include but is not limited to any water surface object that can sway on the water surface. Specifically, the water surface object described in the present embodiment may be a water surface vehicle V, such as a ship, etc., and the present invention is not limited thereto.

In addition, the processing module 100 of the present embodiment can further perform object recognition on the water surface object through the monitoring image of the camera 300a and the camera 300b. Specifically, the object recognition of the present embodiment is to confirm the image category of the water surface object.

The object recognition is achieved by the processing module 100 which is running the image recognition artificial intelligence model. Specifically, the storage module 200 of the present embodiment can store an image recognition artificial intelligence model for providing processing module 100 with the ability to run and detect or identify water surface object which appears in the monitoring image of the camera 300a or the camera 300b.

Of course, the image recognition artificial intelligence model can also be accessed by the processing module 100 through the network to access the image recognition artificial intelligence model on the cloud server. Furthermore, when the processing module 100 is configured in the camera 300a or the camera 300b in the form of single-chip microcomputer, the image recognition artificial intelligence model can also be run in the camera 300a or the camera 300b by itself, and the present invention is not limited thereto. Specifically, in the present embodiment, the image recognition artificial intelligence model of the processing module 100 is yolov3-tiny. The image recognition artificial intelligence model is trained via at least one water surface object data set which is stored in the storage module 200, and be implemented only after confirming that the detection accuracy rate and recognition accuracy rate are both above 85 percent.

Therefore, the image recognition artificial intelligence model of the present embodiment is trained and run by the processing module 100 that may match the hardware specifications of the camera 300a and the camera 300b. The camera 300a and the camera 300b detect all water surface objects within 1.5 Kilometers from the camera 300a and the camera 300b to achieve over 85 percent detection accuracy rate and recognition accuracy rate without optical magnification or digital magnification. Further, when the distance of the water surface object exceeds 1.5 Kilometers from the camera 300a and the camera 300b, the processing module 100 may control the camera 300a and the camera 300b to track the water surface object within the range from 0.5 Kilometers to 6 Kilometers by optical magnification or digital magnification to assist in identification.

Therefore, the processing module 100 of the present embodiment can utilize at least one water surface object data set which is stored in the storage module 200 to identify the image category of the at least one water surface object by object recognition.

In the present embodiment, the image category may include but is not limited to Container ship, Oil tanker, Fishing, Yacht or Warship, etc. The image category which can be identified of the present embodiment is determined by the image recognition artificial intelligence model which is run by the processing module 100. Further, the image recognition artificial intelligence model is determined by the training results of the data content of the water surface object data set stored in the storage module 200.

In other words, if the image recognition artificial intelligence model which is performed by the processing module 100 of the present embodiment can be used to identify and define the category of ship according to but not be limited to the ship classification in the automatic identification system. Therefore, the water surface object data set which is stored in the storage module 200 should store at least but not be limited to the manually labeled Wing In Grnd (airfoil), Hydrofoil, Patrol Vessel, Local vessel, Fishing, Tug, Ferry, Dredger, Cruise ship, Naval ship, Container ship, Sailing vessel, Bulk carrier, Pleasure Craft, Tanker, Hovercraft, Submarine, Search and rescue vessel, Port Tender, Pollution control vessel, Hospital ship, Special vessel, Pilot vessel and image file of distant ship.

On the other hand, the storage module 200 connects to the processing module 100 of the present embodiment may be a component such as a Solid State Drive (SSD). The storage module 200 may store at least one water surface object data set. The at least one water surface object data set may be a water surface object data set which has been manually labeled and provided the processing module 100 with the location and category of the water surface object to detect and identify. Therefore, the processing module 100 of the present embodiment for running image recognition artificial intelligence includes Central Processing Unit (CPU), Graphics Processing Unit (GPU), single-chip microcomputer and combinations thereof.

The water surface object information receiving module 400 of the present embodiment connects to the processing module 100. The plurality of water surface object information includes the position, direction and size of the water surface object. The water surface object information receiving module 400 includes Automatic Identification System (AIS) receiving station. The Automatic Identification System (AIS) receiving station may be a building or equipment with Vessel Traffic Service (VTS), and the present invention is not limited thereto. The information received by the processing module 100 and the water surface object information receiving module 400 can be used to identify where the actual installation location of Automatic Identification System (AIS) of the water surface object, which is configured on the fore part, midship part or after part of the water surface object. The at least one water surface object information tag is respectively labeled on the fore part, midship part, after part of the at least one water surface object in the at least one monitoring image.

Specifically, the receiving station for receiving the Automatic Identification System (AIS) signal of the water surface object information receiving module 400 of the present embodiment may be configured to be in plural form, and the present invention is not limited. In addition, each of the Automatic Identification System (AIS) receiving station should be able to receive the Automatic Identification System (AIS) signal sent from the at least one water surface object within a range of at least 20 nautical miles.

Therefore, the water surface object information receiving module 400 receives the plurality of water surface object information in an interval time and the water surface object information receiving module 400 sends the plurality of water surface object information to the processing module 100. In the present embodiment, the interval time set by the water surface object receiving module 400 is 60 seconds; or the interval time of the water surface object information which is received over 60 seconds will be discarded. The plurality of water surface object information of the present embodiment are Automatic Identification System (AIS) signals.

Further, Automatic Identification System (AIS) includes Global Positioning System (GPS) coordinate, category of ship and Maritime Mobile Service Identity (MMSI), ship name, ship speed, heading direction and the combination thereof. Basically, the aforementioned water surface object data set is established according to aforementioned category of ship. The water surface object information receiving module 400 of the present embodiment accepts the category of ship which includes Wing In Grnd (airfoil), Hydrofoil, Patrol Vessel, Local vessel, Fishing, Tug, Ferry, Dredger, Cruise ship, Naval ship, Container ship, Sailing vessel, Bulk carrier, Pleasure Craft, Tanker, Hovercraft, Submarine, Search and rescue vessel, Port Tender, Pollution control vessel, Hospital ship, Special vessel, Pilot vessel and combinations thereof.

In light of the Automatic Identification System (AIS) may update the category of ship. When the Automatic Identification System (AIS) updates the relevant category of ship, the water surface object data set of the present embodiment may be updated by establishing new data set via the user to improve the recognition capability of the processing module 100.

Accordingly, the processing module 100 of the present embodiment matches the camera positioning information from the camera 300a and the camera 300b, image category of the water surface object identified by the processing module 100 in the monitoring image from the camera 300a and the camera 300b and the plurality of water surface object information from water surface object information receiving module 400.

In present embodiment, considering that the water surface object information includes the information such as category of ship and Maritime Mobile Service Identity (MMSI), etc., which may be used to combine with the camera positioning information from the acquisition between the processing module 100 and the camera 300a and the camera 300b and the image category of water surface object identified by the processing module 100, resulting in the generation of at least one water surface object information tag. Furthermore, the processing module 100 may label the water surface object information tag on the water surface object is the best of the matching result in the monitoring image after the water surface object information tag matching procedure performed by the processing module 100.

Specifically, the processing module 100 of the present embodiment matches the water surface object in the monitoring image and labels and renews the water surface object tag in real-time. The processing module 100 compares part of Global Positioning System (GPS) coordinate of the plurality of water surface object information with the camera positioning information of the camera 300a or the camera 300b. After selecting the camera 300a or the camera 300b having Global Positioning System (GPS) coordinate of the target water surface object, the processing module 100 compares the Global Positioning System (GPS) coordinate of the target water surface object with the camera positioning information of the camera 300a or the camera 300b to form image coordinate in the monitoring image of the camera 300a or the camera 300b.

Based on this, the image coordinate in the camera 300a or the camera 300b are further compared with category of ship, Maritime Mobile Service Identity (MMSI), ship name, ship speed, heading direction and water surface object of the combination thereof, and the processing module 100 labels the water surface object information tag on the target water surface object. The processing module 100 and water surface object information receiving module 400 receive information such as Global Positioning System (GPS) and heading direction of the water surface vehicle V from the nautical instrument VC, thereby determining the Automatic Identification System (AIS) configuring site where is on the fore part of the water surface object, midship part of the water surface object or after part of the water surface object. Specifically, the at least one water surface object information tag will be labeled on the fore part of the water surface object, midship part of the water surface object, or after part of the water surface object in the at least one monitoring image.

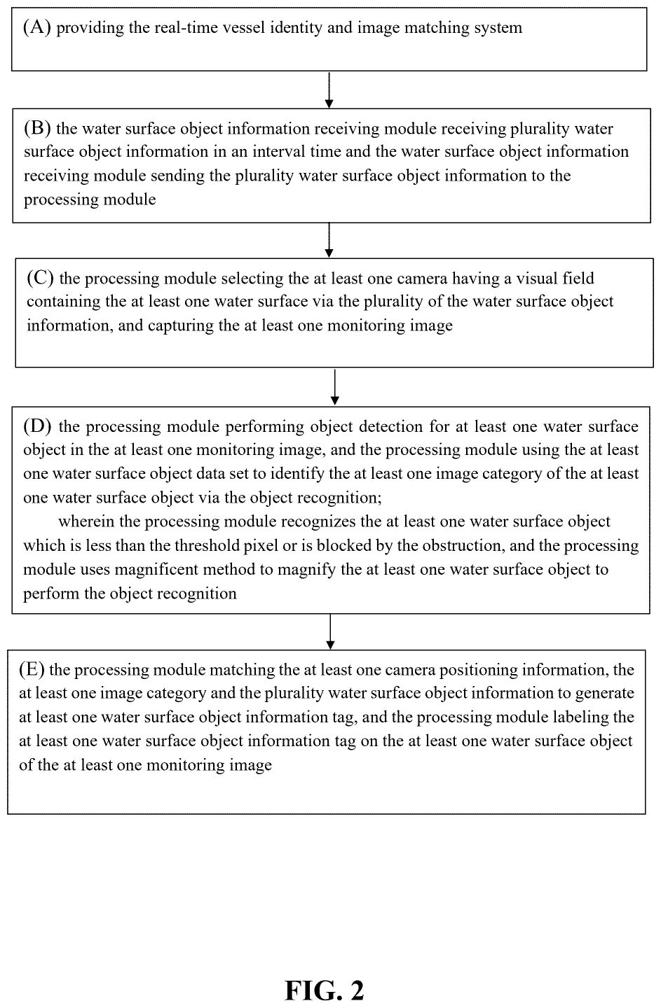

Please refer to FIG. 1 and FIG. 2 simultaneously. FIG. 2 is a flow chart of the operating method of the real-time vessel identity and image matching system of the embodiment of the present invention. As shown in FIG. 2, the present embodiment of the step (A) is providing the real-time vessel identity and image matching system 10 as in the previous embodiment (i.e., FIG. 1). The step (B) is the water surface object information receiving module 400 receiving a plurality of water surface object information in an interval time and the water surface object information receiving module 400 sending the plurality of water surface object information to the processing module 100. The interval time of the present embodiment is 60 seconds.

In light of the updating frequency of the water surface object information receiving module 400 in the present embodiment is not as fast as the camera 300a and the camera 300b which is real-time. Therefore, the step (C) is the processing module 100 selecting the at least one camera (the camera 300a or the camera 300b) having a visual field which contains the at least one water surface object via the plurality of water surface object information, and at least one camera (the camera 300a or the camera 300b) capturing the at least one monitoring image with a rotation angle between 0 degree and 360 degrees and a horizontal wide between 1 degree and 180 degrees. Specifically, the camera 300a or the camera 300b of the present embodiment includes the camera positioning information. Therefore, the processing module 100 may select the most suitable the camera 300a or the camera 300b after it considers the camera positioning information.

In step (D) of the present embodiment, the processing module 100 performs object detection according to at least one water surface object captured in the at least one monitoring image by the camera 300a or the camera 300b. The processing module 100 further uses the at least one water surface object data set which is stored in the storage module 200 to identify at least one image category of at least one water surface object via object recognition.

Specifically, the object recognition is also achieved by the processing module 100 running aforementioned image recognition artificial intelligence model. The image category may be, but is not limited to Container ship, Tanker, Fishing, Pleasure Craft or Naval ship, etc. The category of ship that can be identified in the present embodiment is determined by the image recognition artificial intelligence model which is run by the processing module 100. Furthermore, determination made by the image recognition artificial intelligence model is determined by a training result of the data content of the water surface object data set stored in the storage module 200.

Of course, when the processing module 100 of the present embodiment is identifying the category of the water surface object and finding that the water surface object in the monitoring image is smaller than a threshold pixel or is blocked by the any obstruction, the processing module 100 will activate a detailed object recognition method. The threshold pixel of length or width of the water surface object in the monitoring image is 100 pixels. Specifically, the detailed object recognition method is that the processing module 100 controls the camera 300a or the camera 300b and the processing module 100 uses magnificent method to magnify the water surface object in the monitoring image. The magnificent method includes but is not limited to optical magnification, digital magnification and the combination thereof, to increase the displaying area of the water surface object.

Next, the processing module 100 runs the aforementioned image recognition artificial intelligence model according to the water surface object data set which is stored in the storage module 200. The processing module 100 performs object recognition on at least one identifiable characteristic object on the water surface object after the water surface object being magnified by the magnificent method. In the present embodiment, the at least one characteristic object includes but is not limited to fore part of the water surface object, after part of the water surface object, chimney, boom, lifeboat, flag, color, radar, naval gun, identification plate and the combination thereof. In contrast, when there is special characteristic object that needs to be identified, it should be understood that the water surface object data set which is stored in the storage module 200 also has corresponding labeled related image, and the water surface object data set is provided to the image recognition artificial intelligence model for training. The present invention is not limited. Finally, the processing module 100 may identify the image type of the water surface object according to the at least one identified characteristic object category, and then go to the step (E).

In abovementioned steps (A) to (D) of the present embodiment, when any of the recognition or identification steps encounters that the visible light brightness of the monitoring image is lower than a recognition brightness threshold, the processing module 100 may activate the built-in invisible light sensing function of the camera 300a or the camera 300b. The recognition brightness threshold is 0.001 lux.

Specifically, the brightness threshold may be determined via a light sensor connected to the processing module 100. The light sensor may measure the lux value of ambient visible light to determine whether the weather is cloudy, or the various weather sensors (such as barometer, hygrometer, suspended particle sensor or thermometer, etc.) connected to the processing module 100 may also determine that whether conditions may obstruct or prevent the camera 300a or the camera 300b from receiving visible light or not, and the present invention is not limited.

At the same time, in the present embodiment, when the processing module 100 mainly processes the camera 300b configured on the water surface vehicle V, the water surface vehicle which carries the camera 300b further feeds back the camera navigation correction signal through the navigation device VC to the processing module 100. Accordingly, the processing module 100 corrects the camera positioning information of the camera 300b according to camera navigation correction signal.

Finally, step (E) is the processing module 100 matching the camera positioning information of the camera 300a and the camera 300b, the image category of the water surface object in the monitoring image of the camera 300a and the camera 300b which is identified by the processing module 100, and the plurality of water surface object information which is from the water surface object information receiving module 400. Furthermore, the processing module 100 labels the generated water surface object information tag on the corresponding water surface object in the monitoring image.

As is understood by a person skilled in the art, the foregoing preferred embodiments of the present invention are illustrated of the present invention rather than limiting of the present invention. It is intended to cover various modifications and similar arrangements included within the spirit and scope of the appended claims, the scope of which should be accorded the broadest interpretation so as to encompass all such modifications and similar structure. While the preferred embodiment of the invention has been illustrated and described, it will be appreciated that various changes can be made therein without departing from the spirit and scope of the invention.

What is claimed is:

1. A real-time vessel identity and image matching system, comprising:
a processing module;
a storage module, connected to the processing module;
wherein the storage module comprises at least one water surface object data set;
at least one camera, connected to the processing module;
wherein the at least one camera comprises at least one camera positioning information, and the at least one camera captures at least one monitoring image;
wherein the processing module performs object detection for at least one water surface object of the at least one monitoring image, and the processing module uses the at least one water surface object data set to identify at least one image category of the at least one water surface object via object recognition;
a water surface object information receiving module, connected to the processing module;
wherein the water surface object information receiving module receives a plurality of water surface object information in an interval time and the water surface object information receiving module sends the plurality of water surface object information to the processing module;
wherein the processing module matches the at least one camera positioning information, the at least one image category and the plurality of water surface object information to generate at least one water surface object tag, and the processing module labels the at least one water surface object tag on the at least one water surface object in the at least one monitoring image; and
wherein the processing module recognizes the at least one water surface object which is less than a threshold pixel or is blocked by an obstruction, and the processing module uses magnificent method to magnify the at least one water surface object to perform the object recognition.

2. The real-time vessel identity and image matching system as claimed in claim 1, wherein the processing module comprises Central Processing Unit (CPU).

3. The real-time vessel identity and image matching system as claimed in claim 1, wherein the processing module comprises Graphics Processing Unit (GPU).

4. The real-time vessel identity and image matching system as claimed in claim 1, wherein the at least one water surface object is water surface vehicle.

5. The real-time vessel identity and image matching system as claimed in claim 1, wherein the threshold pixel is 100 pixels.

6. The real-time vessel identity and image matching system as claimed in claim 1, wherein the plurality of the water surface object information is Automatic Identification System (AIS) signal, and the plurality of water surface object information comprises Global Positioning System (GPS) coordinate, category of ship and Maritime Mobile Service Identity (MMSI).

7. The real-time vessel identity and image matching system as claimed in claim 1, wherein the plurality of the water surface object information is ship name, ship speed, heading direction, Automatic Identification System (AIS) configuration site and combinations thereof.

8. The real-time vessel identity and image matching system as claimed in claim 7, wherein the Automatic Identification System (AIS) configuration site comprises fore part of ship, midship part of ship or after part of ship.

9. The real-time vessel identity and image matching system as claimed in claim 8, wherein the at least one water surface object information tag is labeled on the fore part, midship part or after part of the at least one water surface object in the at least one monitoring image.

10. The real-time vessel identity and image matching system as claimed in claim 6, wherein the category of ship comprises Wing In Grnd (airfoil), Hydrofoil, Patrol Vessel, Local vessel, Fishing, Tug, Ferry, Dredger, Cruise ship, Naval ship, Container ship, Sailing vessel, Bulk carrier, Pleasure Craft, Tanker, Hovercraft, Submarine, Search and rescue vessel, Port Tender, Pollution control vessel, Hospital ship, Special vessel, Pilot vessel and combinations thereof.

11. The real-time vessel identity and image matching system as claimed in claim 1, wherein the at least one camera is bullet camera, dome camera or speed dome camera.

12. The real-time vessel identity and image matching system as claimed in claim 1, wherein the at least one camera captures the at least one monitoring image at horizontal wide angle which is ranged from 1 degree to 180 degrees.

13. The real-time vessel identity and image matching system as claimed in claim 1, wherein the at least one camera is configured on the water surface vehicle, shore and combinations thereof.

14. The real-time vessel identity and image matching system as claimed in claim 13, when the at least one camera is configured on end of the water surface vehicle, the at least one water surface vehicle which carries the at least one camera feeds back at least one camera navigation correction signal to the processing module, and the processing module corrects the at least one camera positioning information via the at least one camera navigation correction signal.

15. An operating method of a real-time vessel identity and image matching system, comprising the following steps:
(A) providing the real-time vessel identity and image matching system as claimed in claim 1;
(B) the water surface object information receiving module receiving the plurality of water surface object information in an interval time and the water surface object information receiving module sending the plurality of water surface object information to the processing module;
(C) the processing module selecting the at least one camera having a visual field containing the at least one water surface object via the plurality of the water surface object information, and capturing the at least one monitoring image;
(D) the processing module performing object detection for at least one water surface object in the at least one monitoring image, and the processing module using the at least one water surface object data set to identify the at least one image category of the at least one water surface object via the object recognition;
wherein the processing module recognizes the at least one water surface object which is less than the threshold pixel or is blocked by the obstruction, and the processing module uses magnificent method to magnify the at least one water surface object to perform the object recognition; and
(E) the processing module matching the at least one camera positioning information, the at least one image category and the plurality of water surface object information to generate at least one water surface object information tag, and the processing module labeling the at least one water surface object information tag on the at least one water surface object of the at least one monitoring image.

16. The operating method of the real-time vessel identity and image matching system as claimed in claim 15, wherein the plurality of the water surface object information is Automatic Identification System (AIS) signal, and the plurality of the water surface object information includes Global Positioning System (GPS) coordinate, category of ship and Maritime Mobile Service Identity (MMSI).

17. The operating method of the real-time vessel identity and image matching system as claimed in claim 15, wherein the plurality of the water surface object information is ship name, ship speed, heading direction and combinations thereof.

18. The operating method of the real-time vessel identity and image matching system as claimed in claim 16, wherein the category of ship comprises Wing In Grnd (airfoil), Hydrofoil, Patrol Vessel, Local vessel, Fishing, Tug, Ferry, Dredger, Cruise ship, Naval ship, Container ship, Sailing vessel, Bulk carrier, Pleasure Craft, Tanker, Hovercraft, Submarine, Search and rescue vessel, Port Tender, Pollution control vessel, Hospital ship, Special vessel, Pilot vessel and combinations thereof.

19. The operating method of the real-time vessel identity and image matching system as claimed in claim 15, wherein the at least one camera is configured on the water surface vehicle, shore and combinations thereof.

20. The operating method of the real-time vessel identity and image matching system as claimed in claim 15, wherein the at least one camera is configured on end of the water surface vehicle, and the water surface vehicle which carries the at least one camera feeds back at least one camera navigation correction signal to the processing module, and the processing module corrects the at least one camera positioning information via the at least one camera navigation correction signal.

21. The operating method of the real-time vessel identity and image matching system as claimed in claim 15, wherein the at least one camera takes the at least one monitoring image at rotation angle ranged from 0 degree to 360 degrees.
